(19) United States
(12) Patent Application Publication
(10) Pub. No.: US 2009/0121049 A1
(43) Pub. Date: May 14, 2009

(54) Internal lower fuel injector filter

(76) Inventors: Vicki A. Flynn, Penfield, NY (US); Allan R. Wells, Rochester, NY (US); Dominic N. Dalo, Rochester, NY (US); David A. Webb, Rochester, NY (US); Otto Muller-Girard, JR., Rochester, NY (US); Ross G. Laing, Rochester, NY (US)

Correspondence Address: DELPHI TECHNOLOGIES, INC., M/C 480-410-202, PO BOX 5052, TROY, MI, 48007, US

(21) Appl. No.: 11/983,818

(22) Filed: Nov. 13, 2007

(51) Int. Cl. B05B 1/30

(52) U.S. Cl. 239/575

(57) ABSTRACT

An internal lower filter for a fuel injector includes a self-supporting guide guiding a reciprocably activated valve of an internal valve assembly of a fuel injector and a plurality of filter holes formed in said guide filtering fuel flowing through the fuel injector and preventing contaminants contained in the fuel from entering a sealing area of the internal valve assembly. Incorporating the guide filter in accordance with the invention in a fuel injector enables capturing particles or contaminants, generated within the fuel injector during assembly or during operation, before entering the sealing area of an internal valve assembly. Accordingly, failure modes of the injector, such as a stuck open condition that may lead to a hydraulic lock of the engine, can be reduced. By forming the filter holes in a typically used ball guide, no changes are required to the currently used assembly line equipment or the current assembly process.

### TECHNICAL FIELD

The present invention relates to fuel injection systems of internal combustion engines; more particularly, to fuel injectors; and most particularly, to an internal lower filter of a fuel injector.

### BACKGROUND OF THE INVENTION

Fuel injected internal combustion engines are well known. Fuel injection is a way of metering fuel into an internal combustion engine. Fuel injection arrangements may be divided generally into multi-port fuel injection (MPFI), wherein fuel is injected into a runner of an intake manifold ahead of a cylinder intake valve, and direct injection (DI), wherein fuel is injected directly into the combustion chamber of an engine cylinder, typically during or at the end of the compression stroke of the piston.

A typical fuel injector includes an internal valve assembly that may include a beveled circular seat and a reciprocably actuated ball that seals against the seat in a circular sealing line. A guide that assists in positioning the ball relative to the seat may be included in the internal valve assembly.

It is most desirable, in a modern internal combustion engine, to precisely control the flow of fuel to the combustion chamber in order to meet performance requirements as well as emission regulations. Therefore, it is desirable to ensure that the ball completely seals against the seat when the valve assembly is in a closed position to avoid fuel passage when not needed. It is known to position an upper filter proximate to a fuel inlet of the injector. While the upper filter may capture contaminants generated upstream of the fuel injector, it can not capture contaminants that may be generated during the assembly and/or operation of the fuel injector. It is important to prevent contamination of the area between the ball and the seat. Contamination between the ball and seat may be caused by internally generated particles which may lead to a malfunction of the injector. Malfunction of the injector due to contamination could result in a stuck open condition of one or multiple injectors that may cause a hydraulic lock of the engine. Contaminants may be generated within the fuel injector, for example, during injector assembly operations, such as an assembly tooling or gauging, due to insufficient cleaning of the fuel injector parts prior to assembly, or during operation of the fuel injector, for example, due to friction. It is currently not possible to completely eliminate such internal contamination of a fuel injector.

A stuck open condition can lead to a severe failure mode for the injector and, therefore, injector manufacturing companies try, from both a design and a process stand point, to prevent such a failure mode by eliminating contamination as much as possible. In order to further reduce contamination of the fuel flowing through the injector with particles of internal origin, filters have been disposed internally of the fuel injector between the fuel inlet and the internal valve assembly in the prior art. While such internal filters may prevent internally generated contaminants from reaching the internal valve assembly and from getting stuck between the ball and the seat, integration of such prior art internal filters adds a filter component to the injector assembly, adds components needed to retain the filter components to the injector assembly, and adds internal filter assembly process steps to the assembly process of the injector.

What is needed in the art is an internal filter for a fuel injector that is positioned in close proximity with the internal valve assembly and that does not require additional parts or assembly process steps.

It is a principal object of the present invention to provide an internal lower filter for a fuel injector that is integrated into a ball guide of an internal valve assembly of the fuel injector.

### SUMMARY OF THE INVENTION

Briefly described, a filter for a fuel injector is integrated into a ball guide of an internal valve assembly of the fuel injector that preferably includes a beveled circular valve seat and a reciprocably actuated ball that seals against the seat in a circular sealing line. By including a plurality of filter holes in a ball guide, a guide filter is formed and particulates that may be generated internally in the injector and that may be harmful to the injector operation are captured before reaching the area between the seat and the ball.

The guide filter in accordance with the invention functions both as a ball guide and as an internal lower filter of the fuel injector and, accordingly, eliminates the need for a separate prior art internal filter. Also, handling and assembly of multiple parts as needed to install a prior art internal filter in a fuel injector, can be eliminated with the guide filter in accordance with the invention. By forming the filter holes in the ball guide, the internal lower filter is positioned as close as possible to the seat and ball area of the internal valve assembly of the injector, which enables the capture of a relatively high amount of internal contaminants. Since the filter holes are formed in a commonly used ball guide, no changes to the production injector assembly process are needed. As currently done during assembly of the ball guide, the guide filter in accordance with the invention is press fit into the ball seat prior to the heat treat, grind, and wash operations, which is a current production process. By forming the filter holes in the already used ball guide, no change is required to the currently used assembly line equipment or process.

The guide filter in accordance with the invention may be used preferably in multi-port fuel injection (MPFI) injectors, but may be applicable in direct injection (DI) fuel injectors as well. Integration of a lower internal filter into MPFI injectors is desirable, since due to the lower fuel pressure compared to DI, there is a higher possibility for contaminants to get trapped between the ball seat and the ball resulting in a higher number of injector failures, such as a stuck open condition of an injector or hydraulic lock of the engine. Application of the guide filter in accordance with the invention in MPFI fuel injectors may reduce the occurrence of injector failures by reducing the number of stuck open conditions in injectors, and by reducing the number of hydro lock engine incidents.

### BRIEF DESCRIPTION OF THE DRAWINGS

The present invention will now be described, by way of example, with reference to the accompanying drawings, in which:

FIG. 1 is a partial cross-sectional view of a fuel injector, in accordance with the invention;

FIG. 2 is a top plan view of a guide filter, in accordance with the invention;

FIG. 3 is a cross-sectional view along line 3-3 in FIG. 2 of the guide filter, in accordance with the invention; and

FIG. 4 is a cross-sectional view of the guide filter installed in a valve seat, in accordance with the invention.

Corresponding reference characters indicate corresponding parts throughout the several views. The exemplification set out herein illustrates a referred embodiment of the invention, in one form, and such exemplification is not to be construed as limiting the scope of the invention in any manner.

### DESCRIPTION OF THE PREFERRED EMBODIMENTS

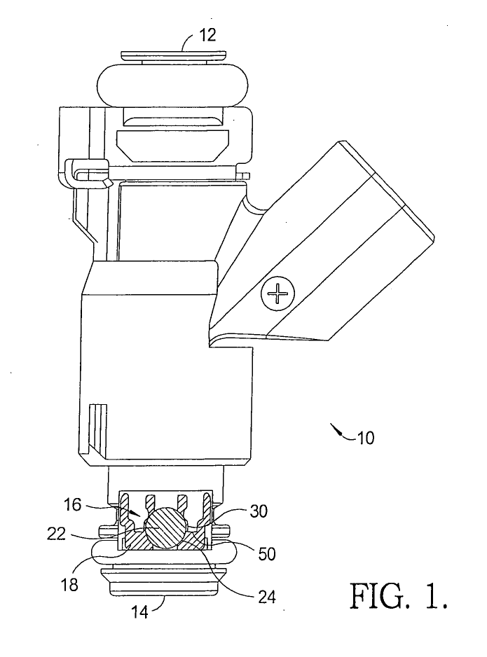

Referring to FIG. 1, a fuel injector 10 includes a fuel inlet 12, a fuel outlet 14, and an internal valve assembly 16. Internal valve assembly 16 includes a valve seat, such as a beveled circular seat 18, and a reciprocably actuated valve, such as ball 22, that seals against seat 18, for example, in a circular sealing area 24. Internal valve assembly 16 regulates the fuel flow through fuel outlet 14. Internal valve assembly 16 further includes a guide filter 30 positioned in close proximity to and upstream of sealing area 24 that functions both as a guide for ball 22 and an internal lower filter. Internal valve assembly 16 is positioned upstream of and proximate to fuel outlet 14 within fuel injector 10. Fuel injector 10 may further include an upper filter (not shown) positioned in close proximity to fuel inlet 12 filtering the fuel entering fuel injector 10. Fuel injector 10 may be a fuel injector for multi-port fuel injection as shown in FIG. 1. Fuel injector 10 may further be a fuel injector for direct injection.

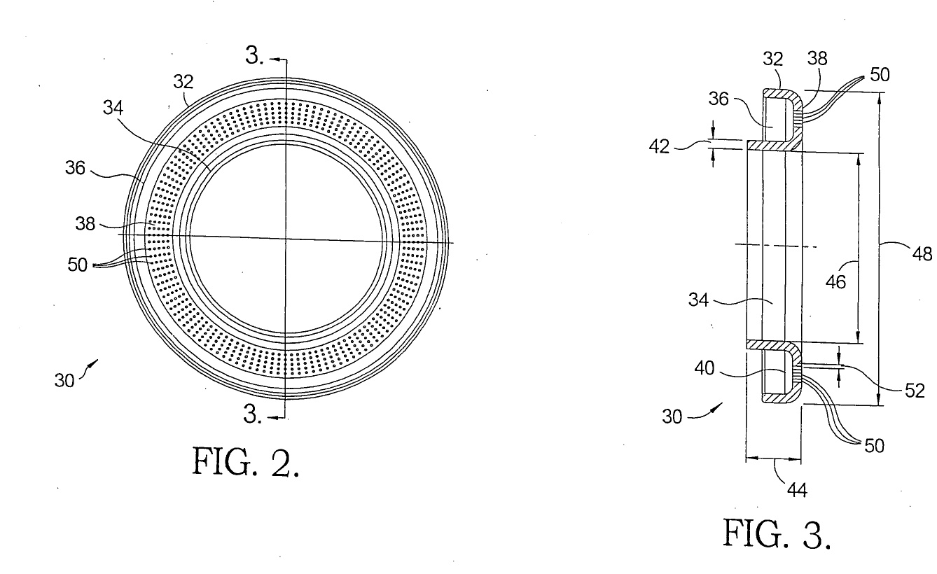

Referring to FIGS. 2 and 3, a guide filter 30 is designed as a ring 32 that has a u-shaped cross-section. Ring 32 includes an inner wall 34 and an outer wall 36 connected at an end by a bottom wall 38 forming a channel 40. Inner wall 34, outer wall 36, and bottom wall 38 have preferably the same thickness 42. The inner circumferential contour of inner wall 34 guides ball 22 and inner wall 34 may, therefore, have a larger height 44 than outer wall 36. Ring 32 may further be designed such that inner wall 34 and outer wall 36 have the same height 44 or such that outer wall 36 has a larger height than outer wall 36. Ring 32 has an inner diameter 46 that is adapted to receive ball 22. Ring 32 has an outer diameter 48 that is adapted to be received by seat 18. Outer diameter 48 may be chosen such that ring 32 may be press fitted into an inner circumferential contour of seat 18. Ring 32 may be assembled in seat 18 such that channel 40 faces fuel inlet 12 of fuel injector 10 (shown in FIG. 1) or such that channel 40 faces fuel outlet 14 (also shown in FIG. 1). Accordingly, ring 32 may be assembled in seat 18 such that bottom wall 38 faces fuel outlet 14 or fuel inlet 12, respectively, of fuel injector 10 as shown in FIG. 1.

Bottom wall 38 of ring 32 includes a plurality of filter holes 50. Filter holes 50 may be formed in bottom wall 38, for example by laser drilling or stamping. Other machining operations may be used to form filter holes 50. To maximize fuel flow through the injector and the filter efficiency of guide filter 30, as many filter holes 50 as can be fit into bottom wall 38 without reducing the stability of ring 32 may be formed in ring 32. Filter holes 50 have a diameter 52 that may be the same for each of the filter holes 50 or that may not be the same for each of the filter holes 50. The diameter 52 of filter holes 50 is preferably smaller than the largest possible distance between ball 22 and seat 18 when valve assembly 16 is in an open position. This way, particles or contaminants that are generated downstream of fuel inlet 12 within fuel injector 10, for example during the assembly process or during operation, and that have a size that may be harmful for injector operation may be captured before reaching sealing area 24.

Thickness 42 of ring 32 and the number of filter holes 50 formed in bottom wall 38 of ring 32 are designed such that the stability of ring 32 is ensured. Accordingly, thickness 42 of ring 32 and the number of filter holes 50 is chosen such that ring 32 is self-supporting and is able to function as a guide for ball 22 and an internal lower filter at the same time. Filter holes 50 may be arranged in a linear pattern as shown in FIG. 2. Other patterns are possible and the pattern of filter holes 50 may depend on the forming process of filter holes 50 in ring 32.

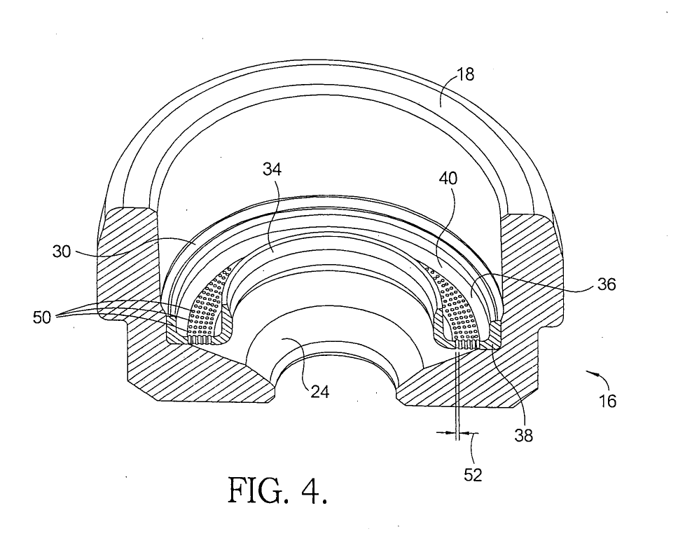

Fuel flowing from fuel inlet 12 to fuel outlet 24 through fuel injector 10 (all shown in FIG. 1) passes through guide filter 30 and any particles or contaminants in the fuel flow that are larger than diameter 52 of filter holes 50 are captured by guide filter 30 and, therefore, precluded from entering sealing area 24 (shown in FIG. 4).

Referring to FIG. 4, guide filter 30 is shown installed in seat 18 of internal valve assembly 16 of fuel injector 10. As can be seen, outer diameter 48 of guide filter 30 fits closely into an inner circumferential contour of seat 18. Inner diameter 46 of guide filter 30 is designed to receive ball 22 (shown in FIG. 1). Filter holes 50 are positioned upstream of sealing area 24 and in close proximity to sealing area 24. Accordingly, guide filter 30 filters fuel flowing through fuel injector 10 before entering sealing area 24 while guiding ball 22.

By capturing particles or contaminants generated within fuel injector 10 with guide filter 30 in accordance with a preferred embodiment of the invention, failure modes of injector 10, such as a stuck open condition that may lead to a hydraulic lock of the engine, can be reduced compared to prior art fuel injectors that are operated without an internal lower filter. By installing guide filter 30 in fuel injector 10 instead of a prior art ball guide and a separate prior art internal lower filter, additional parts of the prior art filter assembly and additional assembly process steps to install the prior art filter are eliminated. Compared to the assembly process of a prior art fuel injector that includes only a ball guide, no changes are required to the assembly line equipment or the assembly process to implement the guide filter 30 in fuel injector 10 in accordance with the invention.

While the guide filter 30 in accordance with the invention may be especially useful for applications in fuel injectors for multi-port fuel injection as described above, guide filter 30 may also be utilized in fuel injectors for direct injection.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

1. An internal lower filter for a fuel injector including a fuel inlet and a fuel outlet, the internal lower filter comprising:
a self-supporting guide including an inner wall, an outer wall, and a bottom wall connecting said inner wall with said outer wall at an end forming a channel for receiving fuel, wherein said bottom wall faces said fuel inlet and wherein said guide guides a reciprocably activated valve of an internal valve assembly of said fuel injector; and
a plurality of filter holes formed in said guide, wherein said filter holes filter fuel flowing through said fuel injector and prevent contaminants contained in said fuel from entering a sealing area of said internal valve assembly.

2. The internal lower filter of claim 1, wherein said guide is a ring having a u-shaped cross-section.

3. The internal lower filter of claim 1, wherein said filter holes are included in said bottom wall.

4. The internal lower filter of claim 1, wherein said valve is a ball that seals against a beveled circular valve seat in a circular sealing area, and wherein said guide is positioned in close proximity to and upstream of said sealing area.

5. The internal lower filter of claim 1, wherein said filter holes are formed by a, laser drilling process.

6. The internal lower filter of claim 1, wherein said guide has an inner diameter that is adapted to receive said valve.

7. The internal lower filter of claim 1, wherein said guide has an outer diameter that is adapted to be received by a valve seat of said internal valve assembly.

8. The internal lower filter of claim 1, wherein all of said filter holes have the same diameter.

9. The internal lower filter of claim 1, wherein each of said filter holes have a diameter that is smaller than the maximum distance between said valve and a valve seat of said internal valve assembly when said valve is in an open position.

10. The internal lower filter of claim 1, wherein said filter holes are arranged in a linear pattern.

11. An internal valve assembly of a fuel injector including a fuel inlet and a fuel outlet, the internal valve assembly comprising:
a beveled circular seat;
a reciprocably actuated ball that seals against said seat in a circular sealing area; and
a guide filter including an inner wall, an outer wall, a bottom wall connecting said inner wall with said outer wall at an end forming a channel for receiving fuel, and a plurality of filter holes, wherein said bottom wall faces said fuel inlet;
wherein said guide filter is positioned upstream of said sealing area;
wherein said guide filter guides said ball; and
wherein said guide filter captures contaminants contained in fuel flowing through said guide filter.

12. The internal valve assembly of claim 11, wherein said guide filter is self-supporting.

13. The internal valve assembly of claim 11, wherein an inner circumferential contour of said inner wall guides said ball, and wherein an outer circumferential contour of said outer wall closely fits into an inner circumferential contour of said seat, and wherein said filter holes are formed in said bottom wall.

14. The internal valve assembly of claim 11, wherein each of said filter holes have a diameter that is smaller than the maximum distance between said ball and a seat when said valve assembly is in an open position.

15. The internal valve assembly of claim 11, wherein a number of said filter holes and a thickness of walls of said guide filter are selected to ensure stability of said guide filter.

16. The internal valve assembly of claim 11, wherein said guide filter is a self-supporting ring having a u-shaped cross-section.

17. The internal valve assembly of claim 11, wherein said guide filter is assembled in a fuel injector for multi-port fuel injection of an internal combustion engine.

18. A fuel injector for multi-port fuel injection in an internal combustion engine, comprising:
a fuel inlet
a fuel outlet, wherein fuel flows through said fuel injector from said fuel inlet to said fuel outlet; and
an internal valve assembly positioned upstream of and proximate to said fuel outlet and regulating flow of said fuel through said fuel outlet;
wherein said internal valve assembly includes a beveled circular seat, a reciprocably actuated ball that seals against said seat in a circular sealing area, and a guide filter positioned in close proximity to and upstream of said sealing area, said guide filter including an inner wall, an outer wall, a bottom wall connecting said inner wall with said outer wall at an end forming a channel for receiving fuel, and a plurality of filter holes that enable passage of said fuel through said guide filter, wherein said bottom wall faces said fuel inlet; and
wherein said guide filter guides said ball and filters said fuel.

19. The fuel injector of claim 18, wherein said guide filter is a ring, and wherein said filter holes are formed in said bottom wall.

20. The fuel injector of claim 18, wherein said guide filter has an inner diameter that is adapted to guide said ball and an outer diameter that is adapted to fit closely into said seat.

21. The fuel injector of claim 18, wherein said guide filter captures particles contained in said fuel that are generated downstream of said fuel inlet and that are harmful to operation of said internal valve assembly.
